(19) United States
(12) Patent Application Publication
(10) Pub. No.: US 2022/0076193 A1
(43) Pub. Date: Mar. 10, 2022

(54) COMMUNICATIONS SERVER APPARATUS AND METHOD FOR OPERATION THEREOF

(71) Applicant: GRABTAXI HOLDINGS PTE., LTD., Singapore (SG)

(72) Inventors: Wenqing CHEN, Singapore (SG); Muchen TANG, Singapore (SG)

(21) Appl. No.: 17/414,817

(22) PCT Filed: Dec. 18, 2018
(86) PCT No.: PCT/SG2018/050617

§ 371 Date: Jun. 16, 2021

(51) Int. Cl. G06Q 10/08

(52) U.S. Cl. CPC G06Q 10/083

(57) ABSTRACT

Communications server apparatus (102) for managing payloads (202, 204) for transport by a vehicle (408), and methods for the operation thereof. The communications server apparatus is configured to, for a plurality of payloads of respective different payload categories (202, 204), each payload category being associated with unique vehicle capability requirements, determine (206), for a first payload of a first payload category, a value of a first payload attribute parameter indicative of a first vehicle capability requirement. For a second payload of a second payload category, a value of a second payload attribute parameter indicative of a second vehicle capability requirement is determined (208). The values for the first and second payload attribute parameters are compared (210) with payload capability data associated with the vehicle, and a comparison result is used (212) to determine a capability of the vehicle to transport both the first and second payloads.

### TECHNICAL FIELD

The invention relates to a communications server apparatus for managing payloads for transport by a vehicle. The invention also relates to a method for managing payloads for transport by a vehicle and computer programs and computer program products comprising instructions for implementing the method.

The invention has particular, but not exclusive, application to real-time pooling of payload items and payload orders for transit vehicles.

### BACKGROUND

Methods for managing payloads for transport by vehicles are known, including methods in which payloads are specified in orders for transportation of those payloads. For example, methods of assigning payloads according to the capacity of a vehicle are known. In one previously considered method, capacity of a vehicle is limited according to the complexity of a combined order. In another previously considered method, payloads are pooled at given pooling points in a route, and compatibility between legs of orders is considered by determining whether there is an overlapping time window spanning the legs. In another previously considered method, orders are grouped by similarity. In a further previously considered method, orders are clustered according to delivery address.

However, such methods typically do not consider different types of payload, which may require different types of capacity in the vehicle. Furthermore these methods do not address real-time pooling of payloads or orders. Moreover none of these methods consider how to manage orders or payloads which have not otherwise been pooled or clustered.

### SUMMARY

Aspects of the invention are defined in the independent claims. Some optional features of the invention are defined in the dependent claims.

Implementation of the techniques disclosed herein may provide significant technical advantages. For example, different types of payloads and payload items can be managed or pooled effectively in the same transport system, allowing far more efficient use of transit capacity. This more efficient use of transit capacity by managing different types of payloads in the same pooling arrangement in turn allows, for instance, greater data processing capacity and lower computational burden for the management system, since fewer vehicles and vehicle transit plans are required for the same amount of payload items. Moreover, vehicles used for examples of transportation arrangements described herein will require less maintenance and will experience less wear and tear for the same amount of payload orders to the system, since the transit efficiency is increased.

Furthermore, management or pooling can be undertaken when vehicles of the system are already in use or in transit, making use of capacity which would otherwise have been unused or underused. In addition, orders or payloads which are not pooled or matched at an initial stage can be re-pooled or re-assigned at further stages in the bundling or pooling process, allowing more orders and/or payloads to be pooled and using more underused capacity of the vehicles. In at least some implementations, the techniques disclosed herein allow for determining payload attributes indicative of vehicle capability for payloads of different categories, and comparing these with payload capability of a vehicle, in order to address the inability of previously considered methods to manage different types of payload requiring different types of vehicle capacity.

### BRIEF DESCRIPTION OF THE DRAWINGS

The invention will now be described, by way of example only, and with reference to the accompanying drawings in which:

FIG. 1 is a schematic block diagram illustrating a communications system having an exemplary communications server apparatus for managing payloads for transport by a vehicle;

FIG. 2 is a flow chart illustrating steps of an exemplary method for managing payloads for transport by a vehicle;

FIG. 3 is a schematic diagram illustrating an example of a series of payloads and orders;

FIG. 4 is a schematic block diagram illustrating an exemplary communications system for managing payloads for transport by a vehicle;

FIG. 5a and FIG. 5b are schematic diagrams illustrating examples of data records and processing of those data records for managing payloads for transport by a vehicle; and

FIG. 6 is a flow chart illustrating steps of an exemplary method for managing payloads for transport by a vehicle.

### DETAILED DESCRIPTION

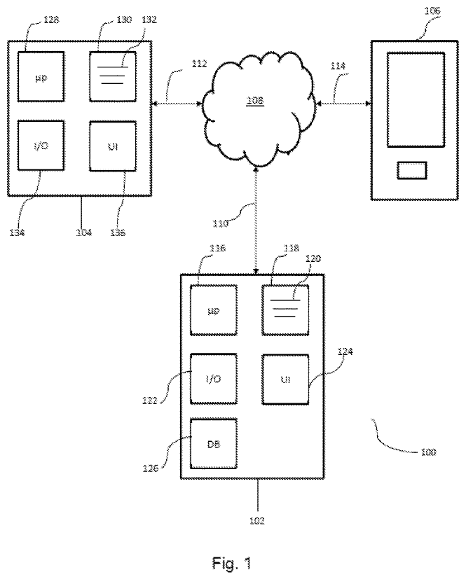

Referring first to FIG. 1, a communications system 100 is illustrated. Communications system 100 comprises communications server apparatus 102, service provider communications device 104 and user communications device 106. These devices are connected in the communications network 108 (for example the Internet) through respective communications links 110, 112, 114. Communications devices 104, 106 may be able to communicate through other communications network, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. In the example of FIG. 1, communications server apparatus 102 may comprise a number of individual components including, but not limited to, microprocessor 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, conventional computing peripheral devices such as display monitors, computer keyboards and the like. Server apparatus 102 may also comprises a database 126.

Service provider communications device 104 may comprise a number of individual components including, but not limited to, microprocessor 128, a memory 130 (e.g. a volatile memory such as a RAM) for the loading of executable instructions 132, the executable instructions defining the functionality the device 104 carries out under control of the processor 128. Device 104 also comprises an input/output module 134 allowing the device 104 to communicate over the communications network 108. User interface 136 is provided for user control. If the service provider communications device 104 is, say, a smart phone or tablet device (or a user interface installed in a vehicle) the user interface 136 will be in the form of a touch panel display as is prevalent in many smart phone and other handheld devices. Alternatively, if the service provider communications device is, say, a conventional desktop or laptop computer, the user interface may take the form of, for example, conventional computing peripheral devices such as display monitors, computer keyboards and the like. Otherwise, if the service provider communications device 104 is, say, a hub or monitoring device, controller or server, or another system processing device, the user interface may take either touch panel or conventional computing forms.

User communications device 106 may be, for example, a smart phone or tablet device with the same or a similar hardware architecture to that of label communications device 104.

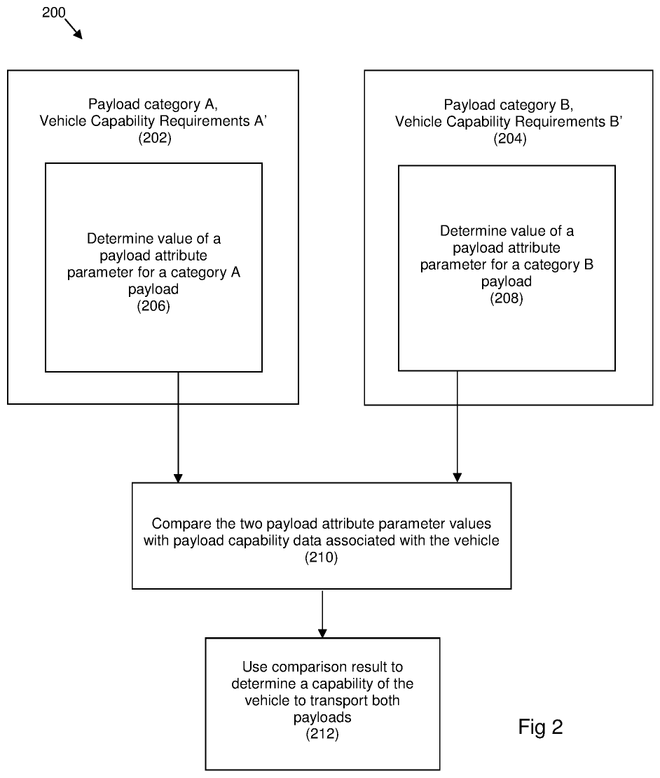

With additional reference to FIG. 2, an exemplary communications server apparatus 102 is for managing payloads for transport by a vehicle, comprising a processor 116 and a memory 118, for example as outlined above. The apparatus is addressed to a plurality of payloads of respective different payload categories, each payload category being associated with unique vehicle capability requirements, such as payload category A (202) and payload category B (204). The communications server apparatus is configured, under control of the processor, to execute instructions 120 in the memory to: determine 206, for a first payload of the first payload category (category A), a value of a first payload attribute parameter indicative of a first vehicle capability requirement; determine 208, for a second payload of the second payload category (category B), a value of a second payload attribute parameter indicative of a second vehicle capability requirement; compare 210 the values for the first and second payload attribute parameters with payload capability data associated with the vehicle; and use 212 a comparison result to determine a capability of the vehicle to transport both the first and second payloads.

As noted above, techniques described herein relate to managing or pooling multiple types of payload into a vehicle transport framework. A number of different types or categories of payload, contents or cargo are considered, such as passengers, and goods such as packages, food items, medicine, flowers and furniture. Thus, the payloads are heterogeneous, rather than homogeneous as in previously considered systems, which only consider for example either cargo, or passengers.

For each vehicle, different types of capacity relating to the different types of payload or contents are determined or obtained (if previously or elsewhere determined). Amounts of capacity for these different types are also determined for each vehicle. This allows pooling of transport orders containing or listing different types of payload, and efficient use of capacity of the vehicles. The orders themselves may originate for example from the user 106 or service provider 104 devices shown in FIG. 1; a user may order a pick up and drop off passenger service for instance, or a service provider may determine that a parcel for delivery to a customer is to be transported via the network.

In an exemplary technique, a number of constraints or conditions are introduced, to allow the management or pooling of payloads and payload items from orders to be optimized, in order to assign payload or cargo efficiently in the pooling process. For example: capacity currently occupied for each payload type in a given vehicle; compatibility of payload types with the vehicle, and compatibility between different payload types within that vehicle; and service level for each payload type, and for each order, can all be used as constraints to determine a valid solution for any given vehicle and the orders or payloads being compared.

In an example, a payload category A is defined as one of the following: passenger; cargo; or perishables. Categories can of course be combined (e.g. a passenger may also come with cargo, such as luggage) but additional categories can be defined for combinations (for example defining an additional category “passenger plus cargo”). A payload category (or class, or type) may therefore cover different payload items (or indeed multiple payload items within a single payload); for example, cargo may be of various sizes and shapes, passengers may have different requirements for their journey; various other factors may be considered for payload items to be accommodated efficiently.

Thus each payload category or payload (or payload item) has associated attributes, characteristics or classifiers/classification which allows the unique or particular requirements for that payload to be managed. For example, for a given payload, payload attributes may include which area of the vehicle the payload may be transported in, the size or shape of the payload, how urgently the payload must be transported, whether there is a maximum or minimum temperature for the payload, and so on.

For a given payload category, certain payload attributes may be implied, others may be defined (for example as specified during processing the order, or by retrieval of stored details from a database), and other attributes may not be assignable to that payload category. For a payload in the passenger category, it will be implied that the passenger must be transported in the cabin of the vehicle (rather than the trunk). It may be defined whether the passenger has other requirements, such as a preferred maximum number of stops, or minimum/maximum other passenger occupants of the vehicle. These may be taken from the passenger's order, or from stored preferences. Other attributes may not be assignable (prevented from being assigned) to a passenger, for example how much trunk capacity is to be used.

For each payload attribute, there will be a value for a payload attribute parameter, to define for the payload or payload item what the precise vehicle capability requirement is. For instance, a payload attribute of maximum temperature for the payload will have a payload attribute parameter value of that maximum temperature, for example 4 degrees Celsius. For a payload attribute of required cabin location, the parameter value may be “trunk” or “cabin” or “refrigerated section”. For a payload attribute of size, there may be several attribute parameters, each having a value; for example, width Xcm, length Ycm, depth Zcm. For a similar or alternative payload attribute of occupancy, the parameter value may for example be a value from 1 to 4 for a number of passenger spaces available, or from 1 to n for a number of standardised cargo spaces occupied. For a weight attribute, the parameter value may be a weight amount, for example 10 kg. For an urgency attribute, the parameter value may be a time at which delivery is limited, for example a time past which a hot food item will be too cold, or a maximum transit time for biological medical items, or a half-life or other index for a medical radioisotope. For a payload category “fragile”, attribute parameters may include a maximum number of stops on a route, or a maximum threshold of stability of driving, or of the quality of the route (the stability/quality having been rated to determine a value for these parameters).

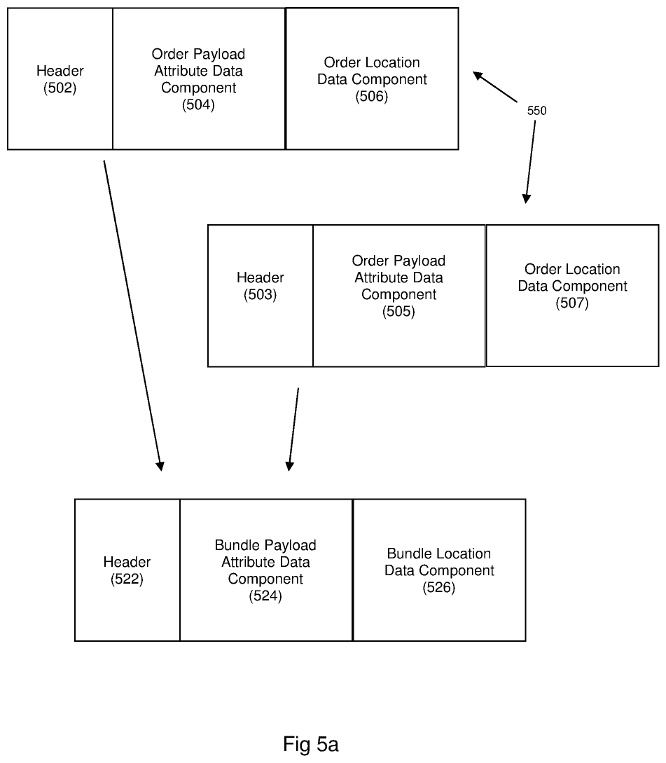

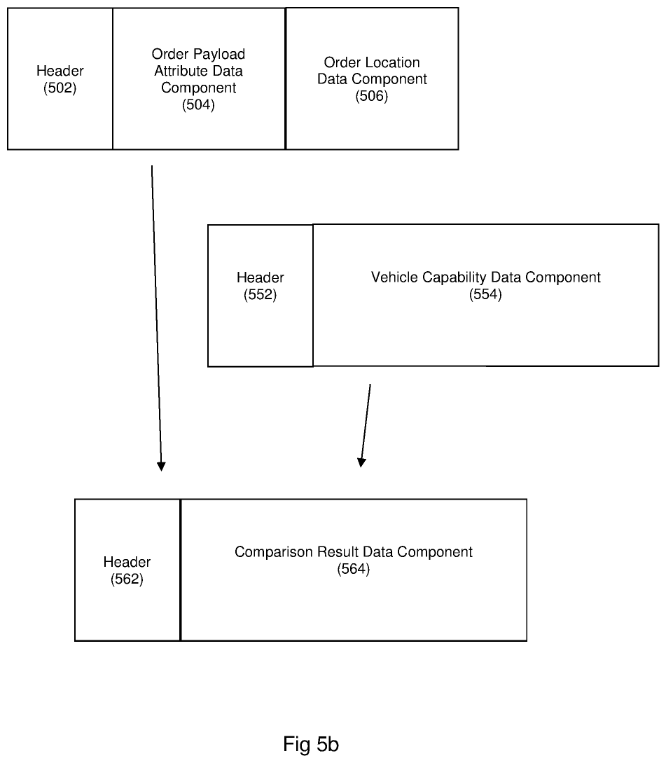

Correspondingly, a payload capability associated with the vehicle may be represented by vehicle attributes and/or vehicle attribute parameter values. These attributes or values may correspond to accommodation of respective payload attribute parameters. For example, for a payload attribute of required cabin location, the value being “trunk”, a vehicle having a vehicle attribute of cabin type with vehicle attribute parameter values being “trunk” and “cabin”, will be compatible. For a vehicle attribute of cabin passenger capacity, a parameter value may be “4” for a five-seater vehicle. These vehicle attributes and parameter values can be recorded in vehicle capability data components in data records such as those illustrated in FIG. 5b.

Referring again to FIG. 2, the payload category A will have unique or particular vehicle capability requirements A′; the capability required of the transporting vehicle will be significantly different for a passenger payload as compared to a cargo payload. For example, a delivery vehicle will likely not have a passenger cabin, and similarly a car which is full of passengers may still have room for cargo in a trunk.

Nevertheless, although different categories of payload will have significantly different attributes which will require significantly different vehicle capability, there will also be attributes that are common to different categories. For example, both passengers and cargo may require delivery or drop off by a certain time.

In addition, comparison of a payload's attribute parameter value with a capability associated with a vehicle may include (or be limited to) comparing the attribute parameter value with that of another payload, for example one that is already occupying the vehicle (or is scheduled to do so). For instance, a size parameter value for a cargo payload item may be compared with that of another cargo payload item, to check that they will both fit into the trunk of a vehicle. If two payloads both require use of a food storage area which is limited to one payload item, this will limit the vehicle capability to transport both, unless they are transported at different stages of a transit.

Furthermore, the comparison(s) may be with not only one but a plurality of vehicles, in order to determine an optimum vehicle for the given payloads or combination of payload categories and attributes.

In examples, the payload category for a given payload or order may be a combination, or include multiple categories, for which parameter values should be obtained. For example, a passenger may also have luggage, requiring both cargo and passenger attributes to be considered.

It may also be noted that the various constraints for the system, represented in this example by categories, and attributes and their parameter values, in comparison with the capability for the vehicle, will also affect each other. For instance, if a cargo payload is scheduled to occupy a cabin area, a passenger will no longer be able to sit there, in spite of that capability having been available initially for that vehicle. If several payload items have time limited attributes, a solution which fully occupies the vehicle with payloads may not also be a solution which satisfies all the time limit constraints, if there are now so many payloads that they will not all reach their destinations in time. Therefore the comparisons made, between payload attributes and vehicle capability, will consider all attributes and parameters in order to find one or more optimal solutions for efficiently managing the multiple payloads together.

Once the payload attribute parameter values have been compared 210 with the capability data associated with the vehicle, a result of this comparison can be used to determine whether the vehicle can indeed transport these payloads. In this way, the characteristics or attributes of the payloads can be used as constraints on the possible solutions for filling or occupying the available vehicle(s). Consequently, these techniques can be used as a method for optimizing allocation or distribution of a set of payloads among a set of available vehicles. Similarly, these techniques can of course be used in a conversely-aimed optimization, to optimize the allocation of a set of available vehicles to a given set of payloads.

Of course, once a system for constraining payload attributes in reference to vehicle capability has been established, this can then be used to bundle or pool orders. These orders may contain details of payloads and their categories and or attributes, and may specify pick-up and drop-off locations for the payload(s). The orders as noted above may for example be from users, for instance ordering a passenger transport between locations, or from a service provider, which may have compiled a cargo and pick-up and drop-off locations into an order.

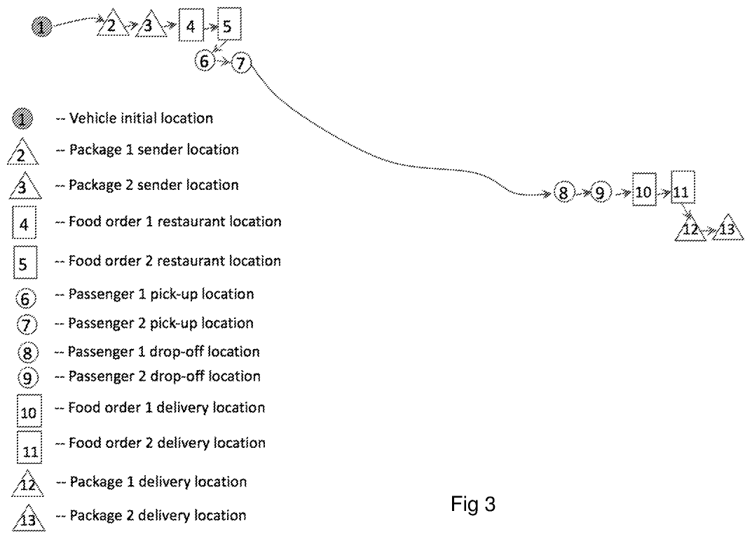

FIG. 3 is a schematic diagram illustrating an example of a series of payloads and orders. A given vehicle has an initial location 1. A first package 2 has a sender location, and a second package 3 has a different sender location. The vehicle leaves the initial location and travels to pick up 2 and 3. The vehicle then travels to pick up a first food payload at a first food order restaurant location 4, and a second food payload at a second food order restaurant location 5. The vehicle then picks up a first passenger at location 6, and a second passenger at location 7. The vehicle then travels to the respective drop-off locations for these respective payloads. The first passenger is dropped at location 8, and the second at location 9. The first food order is dropped at 10, the second at 11. Finally the first package is dropped at location 12, the second package at 13.

These payloads may of course originate from multiple orders made by users or service providers. For example, the first and second passengers in separate locations are likely to have resulted from separate orders by two different users. The two packages in separate locations may be from different orders, by the same or different users or service providers. The two food orders may have been ordered for the same user, from different locations, or for different users.

These payloads in this case can all be accommodated in the same vehicle, and this will have been determined for example by processes as outlined above, by constraining attributes of the payloads, determining values for attribute parameters and comparing these with the capability of the vehicle, and with the planned occupation by the other payloads in this collection of orders, referred to herein as an order bundle.

In addition, the pick-up and drop off locations can be managed in collecting, aggregating or bundling orders, in order to produce order bundles or sets that are not only efficient from the point of view of capability use, but also from the point of view of distance travelled by the vehicle.

For example, given an initial groups of orders including payloads and locations, initially any payloads or orders with locations outside a given threshold distance (e.g. from an initial order) can be rejected. Comparison of orders can therefore be undertaken, either initially to group orders by similarity of location(s), and subsequently optimized by efficient vehicle usage as described above, or vice versa. A third mode can optimize both facets in parallel.

In an exemplary technique, the comparison of order locations is carried out by analysing the order locations as a graph problem. The pick-up and drop-off locations of all orders are represented as nodes in the graph. The links between any two nodes are represented as arcs in the graph. In addition, the current vehicle location may be included in the graph analysis.

In one example, two sets of orders are compared, each order containing payloads and locations. A matching score for the two groups of orders is calculated based on modelling solutions as a travelling salesman problem (TSP), a modelling paradigm known to the art. Essentially this type of modelling determines the shortest route which will visit all the nodes in a graph. Thus two sets of orders can be compared by determining how much further will need to be travelled in order to fulfil both sets of orders. Therefore different comparisons of groups of orders can be assessed by comparison of their increase in travel time. A threshold combined direct trip time can be set to reject any orders or groups of orders which increase the trip time excessively. In an example an order batching efficiency score is calculated as:

Order Batching Efficiency=Total Order Direct Trip Time/Batched Driver Trip Time.

Where the total order direct trip time is the time taken for each group of orders to be fulfilled in separate trips, and the batched driver trip time is the time taken for all the orders to be fulfilled in a combined trip.

Whilst orders can be collected or bundled in this way, the constraints described above may also be applied. Therefore, in a matching process in an exemplary technique, the orders may be compared to find an adequately efficient bundle, but orders may be rejected if the payloads in the order are not compatible with the vehicle, or with each other, or with service level requirements for the order/payload/trip time, or if the vehicle is already full for a certain payload.

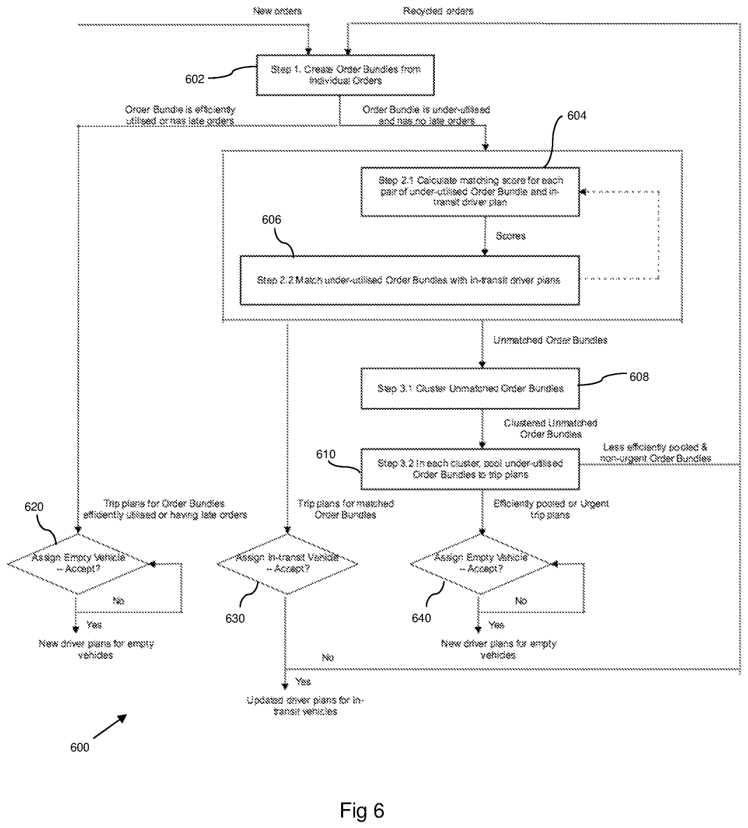

In addition, orders or payloads may be compared with vehicle compatibility data while the vehicles themselves are in-transit. For example, a payload or order may be compared with a vehicle which is already en route between pick and drop locations for other payloads (or is scheduled for these), and may already have payloads assigned or loaded onto the vehicle. The comparison will then be between the payload or order and the vehicle payload or assigned orders, in real-time. Similar exemplary techniques will be described in more detail with reference to FIG. 6 below.

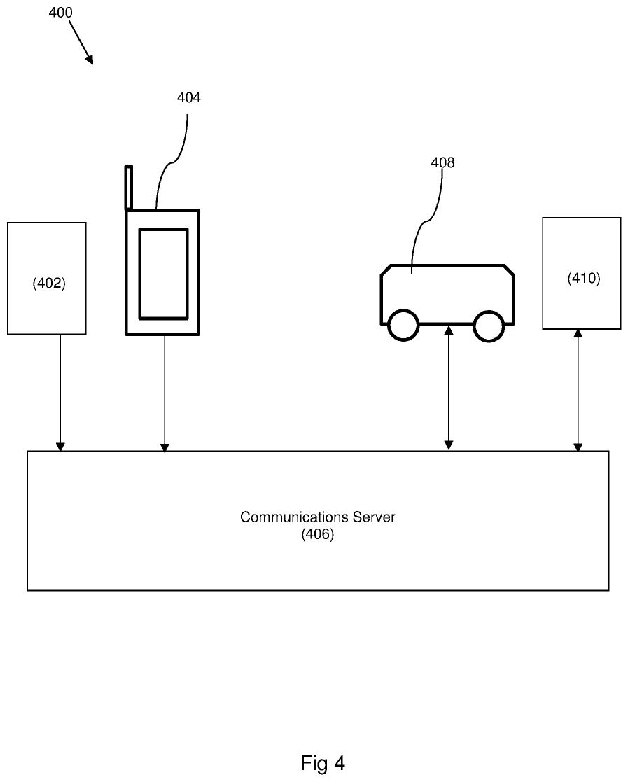

FIG. 4 is a schematic block diagram illustrating an exemplary communications system for managing payloads for transport by a vehicle. A server 402 of a service provider (which may be similar to the device 104 in FIG. 1) and a user device 404 (which may be similar to device 102 in FIG. 1) are devices which create orders. The orders are then transmitted to the communications server 406, which processes the orders and payloads according to the techniques described herein, in order to efficiently manage and/or pool the orders and payloads. The communications server 406 is also in communication with one or more vehicles 408, and server or database 410. Server 410 may provide backup data provision for the vehicles of the transport network, or may store details of trips which the vehicles have made, or are making, or of regular or repeated trips that the vehicles may make.

The information from the vehicles 408 and the server or database 410 are used by the communications server 406 to make the comparisons between payloads and/or orders in order to determine the capabilities of vehicles for those payloads and/or orders as described herein. The communication between the servers 402 and 410, the user device 404 and the vehicle 408 and the communications server 406 may of course be via a network, such as the network 108 shown in FIG. 1.

It may be noted of course that the vehicles 408 may be autonomous vehicles. In such case, the programming for the vehicles may include routes determined by comparisons of payloads and orders according to techniques described herein.

For devices 402 and 404, software applications may include features and functionality in interfaces or GUIs including, but not limited to, one or more of the following: a section for inputting a start or origin location for the service being requested; a section for inputting a destination location for the service being requested; a section for selecting a service type (e.g., taxi, private car, ride-share or car-pool, shuttle, bus, delivery, etc.); a map, which may include indications of a current location of the computing device of the user, the start or origin location for the service being requested, the end or destination location for the service being requested, or location of one or more available service providers; favourite origin and destination locations; and links to other features and functionality.

Some of the processes for managing payloads may be similar to known techniques for managing transport-related services (e.g., taxis, private car services, shuttles, ride shares, e-hailing services, delivery services, etc.) include receiving an order, performing a search for suitable and available service providers or vehicles nearby the location of the user (or start or origin location provided by the user), and matching a suitable and available service provider to the service request.

FIG. 5a and FIG. 5b are schematic diagrams illustrating examples of data records 550 and processing of those data records for managing payloads for transport by a vehicle. In an example of use of the systems described herein, a user communication device (e.g. mobile phone) generates data for an order using an application running on the user's device when a user wishes to make an order. The service requester's application outputs a message, typically in the form of packets with headers indicating ID and addressing information for the packet. As shown in FIGS. 5a and 5b, the contents (payload, fields) of the packet consists of the user's order information, and in this example in FIG. 5a this comprises: a payload attribute data component 504, and a location data component 506. A similar data record (from another source, perhaps another user) similarly has a header 503, payload attribute data component 505, and a location data component 507.

The techniques described herein, carried out for instance in exemplary communications server apparatus described herein, can use the data fields of data records 550 to determine a comparison between the data records, as described herein. For example, the location data components 506 and 507 of these data records can be processed to generate a comparison. In this case, the data records are being combined into an order bundle data record, having header 522, a bundle attribute data component 524 (generated by processing the order payload attribute data components of the data records 550), and similarly a bundle location data component 526 (generated by the comparison of the location components).

In FIG. 5b, a vehicle capability data component 554 from one data record is processed in comparison with a payload attribute data component 504 from another, to produce a data component field 564 for another data record (header 562), which field is populated by a comparison result for the comparison between the vehicle capability data component 554 and the attribute data component 504.

In an exemplary technique for bundling and pooling payloads and orders, a number of steps are undertaken:

1. Transport orders are bundled together, for example by location. If a given bundle is over a determined efficiency threshold, or if orders within the bundle are late (too late to be matched in (2)) the bundle is assigned to a new/unoccupied vehicle. Orders are bundled together if their pick-up location and drop-off locations are close to each other. The order bundling reduces the problem size and encourages fast real-time pooling solving time. An advantage of new-order bundling or pooling is from the scale effect—with bigger sets of candidates compared with in-transit pooling, new-order pooling quality can often be better; most pooled bundles are from similar pick-up locations.

2. For bundles under this efficiency threshold, matching scores are determined between bundles and transit plans currently being executed by occupied/in-transit vehicles. Each bundle is compared to each in-transit vehicle transit plan. For matching scores above a threshold, the order bundle is added for the vehicle with the matching transit plan. Once in-transit pooling is done, the driver plan of the in-transit vehicle is immediately updated. In in-transit pooling, a search is performed for all in-transit vehicles. Those vehicles far away from any order pick-up location are eliminated from the candidate sets. This methodology reduces the pre-processing time and the solving time. Advantages of in-transit pooling are that it makes the best use of the capacities of the in-transit vehicles, and that it allows the vehicles to serve more orders before the end of their current trips.

3. Any remaining order bundles are either (a) pooled together and assigned to new/unoccupied vehicles, or if that pooling is not sufficiently efficient, (b) dissembled back to the individual orders, and returned to (1) for re-bundling.

In other exemplary techniques, features of the techniques described above, or with reference to FIG. 6, can be used separately (or in separate combinations); for example in a simpler method than that described with reference to FIG. 6, a preliminary stage comparing orders can be used, in order to provide order bundles. In other techniques, orders (or order bundles) may be compared to orders assigned to a vehicle, during an order fulfilment trip of that vehicle. Optionally, a plurality of orders may be clustered, to improve efficiency of order or payload comparisons.

FIG. 6 is a flow chart 600 illustrating steps of an exemplary method for managing payloads for transport by a vehicle. At Step 1 (602) order bundles are created from individual orders, as described above. These order bundles can either be created from entirely new orders, or from recycled orders (see below), or from a combination of both.

The bundling step 602 may comprise TSP modelling as described above. However, it may also consider constraints such as those described above, so that order bundles are already populated with payloads that are compatible with each other's attributes.

If the order bundle is efficiently utilised, the bundle is passed to be assigned 620 to an empty vehicle. To determine sufficient efficiency for a bundle, a threshold can be applied, as described above. In an example, the efficiency will be calculated thus:

Order Batching Efficiency=Total Order Direct Trip Time/Batched Driver Trip Time. (a)

Driver Trip Load=Number of orders (b)

Both (a) and (b) are criteria used to determine if a bundle (from 602) shall be assigned to an empty vehicle 620.

If at Step 1 the order bundle contains late orders, the bundle will similarly be passed for assignment to a new vehicle even if the two criteria are not met (or if efficiency does not exceed the threshold). This is because late orders will need to be fulfilled urgently, and therefore some efficiency in the order pooling process must be traded off in order to do this.

If at Step 1 the order bundle is under-utilised (and has no late orders), it is passed to Step 2.1 (604) where a matching score is calculated for pairs of the (or each) order bundle with each in-transit driver plan. The comparison process for the matching score can be as described above: TSP modelling can be used to determine how similar the locations are for the order bundle and each driver plan, and in addition (or alternatively) comparisons between payloads and the capability of the in-transit vehicle using constraints can be undertaken as described above.

At Step 2.2 (606), the scores of some of the comparisons will be sufficiently high that the given order bundle can be assigned 630 to that in-transit driver plan which gave the high comparison or matching score. In a particular technique, the comparison scores are optimized using an assignment algorithm or combinatorial optimization algorithm, for example the known Kuhn-Munkres algorithm, so that the overall efficiency is maximized in matching the bundles to the in-transit driver plans.

If this step still has not found a match for the order bundle, at Step 3.1 (608) the under-utilised, unmatched order bundles are then clustered. This may simply be done by taking each batch of order bundles as they come, but in this example the clustering is performed using a cluster size restricted agglomerative clustering method. This clustering methodology does not require predefining the number of clusters. It is based on a nearest-neighbour-chain algorithm, adding cluster size constraint and maximum distance constraint.

Once the order bundles have been clustered, at Step 3.2 (610), the number of order bundles in each cluster is reduced (in comparison to the number of available unmatched bundles for Step 3.1) and a further pooling step is undertaken. This can use TSP modelling, or constraint-applied comparisons, or both. This can provide trip plans from these pooled order bundles. Other techniques can be used for this pooling stage. For example, known Capacitated Vehicle Routing Problem (CVRP) algorithms can be used, such as Capacitated Vehicle Routing Problem with Pickup Delivery and Time Window Constraint (CVRPPDTW), to provide pooled trip plans for these bundles.

If this final stage has produced order bundle trip plans which are over the efficiency threshold (similar to that defined for Step 1), the resultant driver plan is assigned to an empty vehicle.

If there are still in-efficient order bundles after Step 3.2, these are broken up into their constituent orders and used as recycled orders to help create initial order bundles at Step 1.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. Communications server apparatus for managing payloads for transport by a vehicle, comprising a processor and a memory, the communications server apparatus being configured, under control of the processor, to execute instructions in the memory to:
for a plurality of payloads of respective different payload categories, each payload category being associated with unique vehicle capability requirements,
determine, for a first payload of a first payload category, a value of a first payload attribute parameter indicative of a first vehicle capability requirement;
determine, for a second payload of a second payload category, a value of a second payload attribute parameter indicative of a second vehicle capability requirement;
compare the values for the first and second payload attribute parameters with payload capability data associated with the vehicle; and
use a comparison result to determine a capability of the vehicle to transport both the first and second payloads.

2. The communications server apparatus as claimed in claim 1, wherein the apparatus is configured to: initially compare the value for the first payload attribute parameter with the payload capability data; and later compare the value for the second payload attribute parameter with the payload capability data.

3. The communications server apparatus as claimed in claim 1 or claim 2, wherein the payload capability data associated with the vehicle comprises one or more payload attribute parameters for a payload associated with the vehicle.

4. The communications server apparatus as claimed in any preceding claim, wherein the first payload category comprises one of: passengers; cargo; and perishables.

5. The communications server apparatus as claimed in claim 4, wherein the first payload category comprises cargo, and wherein the first payload attribute parameter is one or more of: size; shape; weight; designated loading area; urgency; required temperature; and fragility.

6. The communications server apparatus as claimed in claim 4, wherein the first payload category comprises passengers, and wherein the first payload attribute parameter is one or more of: urgency; and required service level.

7. The communications server apparatus as claimed in claim 4, wherein the first payload category comprises perishables, and wherein the first payload attribute parameter is one or more of: size; shape; weight; perishability; designated loading area; urgency; required temperature; and fragility.

8. The communications server apparatus as claimed in any preceding claim, wherein the payload capability data associated with the vehicle comprises one or more vehicle attribute parameter values corresponding to accommodation of respective payload attribute parameters.

9. The communications server apparatus as claimed in any preceding claim, wherein the apparatus is configured to use payload attribute parameter values and vehicle payload capability data to assign constraints to calculation of solutions for transporting the respective payloads.

10. The communications server apparatus as claimed in any preceding claim, wherein the apparatus is configured to compare the values for the first and second payload attribute parameters with payload capability data associated with the vehicle, during a trip of the vehicle.

11. The communications server apparatus as claimed in any preceding claim, wherein the apparatus is configured to obtain orders for transporting payloads, wherein a first order comprises at least the first payload and at least one first order location; and a second order comprises at least the second payload and at least one second order location.

12. The communications server apparatus as claimed in claim 11, wherein at least the first order is obtained via a communications link to a communications device.

13. The communications server apparatus as claimed in claim 11 or claim 12, wherein the apparatus is configured to compare the first and second order locations with location data associated with the vehicle.

14. The communications server apparatus as claimed in claim 13, wherein the apparatus is configured to, during an order fulfilment trip of the vehicle: compare the values for the first and second payload attribute parameters with payload capability data associated with the vehicle; and compare the first and second order locations with location data associated with the vehicle.

15. The communications server apparatus as claimed in any of the claims 11 to 14, wherein the apparatus is configured, at a preliminary stage preceding comparing the values for the first and second payload attribute parameters with payload capability data associated with the vehicle, to:
preliminarily compare the first and second orders; and
according to a result of the preliminary comparison, to proceed to compare the values for the first and second payload attribute parameters with payload capability data associated with the vehicle.

16. The communications server apparatus as claimed in claim 15, wherein the apparatus is configured to, following preliminary comparison of the first and second orders, compare the first and second orders with an order assigned to the vehicle, during an order fulfilment trip of the vehicle.

17. The communications server apparatus as claimed in claim 16, wherein the apparatus is configured to:
following comparison of the first and second orders with the order assigned to the vehicle, cluster a plurality of orders including the first and second orders; and
compare the first order with a third order determined to be at a minimum clustering distance from the first order.

18. The communications server apparatus as claimed in any preceding claim, wherein the apparatus is configured to: use the determined capability to generate a fulfilment instruction for transmission to the vehicle.

19. A communications system for managing payloads for transport by a vehicle, comprising communications server apparatus, at least one user communications device and communications network equipment operable for the communications server apparatus and the at least one user communications device to establish communication with each other therethrough, wherein the at least one communications device comprises a first processor and a first memory, the at least one communications device being configured, under control of the first processor, to execute first instructions in the first memory to:
generate an order for transporting at least a first payload,
and wherein:
the communications server apparatus comprises a second processor and a second memory, the communications server apparatus being configured, under control of the second processor, to execute second instructions in the second memory to:
for a plurality of payloads of respective different payload categories, each payload category being associated with unique vehicle capability requirements,
determine, for the first payload, being of a first payload category, a value of a first payload attribute parameter indicative of a first vehicle capability requirement;
determine, for a second payload of a second payload category, a value of a second payload attribute parameter indicative of a second vehicle capability requirement;
compare the values for the first and second payload attribute parameters with payload capability data associated with the vehicle; and
use a comparison result to determine a capability of the vehicle to transport both the first and second payloads.

20. A method, performed in a communications server apparatus for managing payloads for transport by a vehicle, the method comprising, under control of a processor of the communications server apparatus:
for a plurality of payloads of respective different payload categories, each payload category being associated with unique vehicle capability requirements,
determining, for a first payload of a first payload category, a value of a first payload attribute parameter indicative of a first vehicle capability requirement;
determining, for a second payload of a second payload category, a value of a second payload attribute parameter indicative of a second vehicle capability requirement;
comparing the values for the first and second payload attribute parameters with payload capability data associated with the vehicle; and
using a comparison result to determine a capability of the vehicle to transport both the first and second payloads.

21. A method according to claim 20, comprising:
comparing the values for the first and second payload attribute parameters with payload capability data associated with one or more further vehicles;
using comparison results to determine capabilities of the further vehicles to transport both the first and second payloads; and
using the determined capabilities to assign one of the vehicles for transport of both the first and second payloads.

22. A computer program product comprising instructions for implementing the claim 20.

23. A computer program comprising instructions for implementing the method of claim 20.
